(19) United States
(12) Patent Application Publication
(10) Pub. No.: US 2005/0259988 A1
(43) Pub. Date: Nov. 24, 2005

(54) Bi-directional optical access network

(76) Inventors: Dae-Kwang Jung, Suwon-si (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(21) Appl. No.: 10/988,824

(22) Filed: Nov. 15, 2004

(30) Foreign Application Priority Data
May 20, 2004 (KR) 2004-35846

(51) Int. Cl. H04J 14/00

(52) U.S. Cl. 398/72

(57) ABSTRACT

A bi-directional optical access network is disclosed. The network includes a central office that generates a plurality of wavelength-locked downstream optical signals, multiplexes the downstream optical signals, and outputs the resultant multiplexed signal. The network also includes a remote node that demultiplexes the multiplexed signal of the downstream optical signals output from the central office, outputs the demultiplexed downstream optical signals to subscriber units, respectively, multiplexes upstream optical signals, and outputs the resultant multiplexed signal of the upstream optical signals to the central office. The subscriber units slice an associated one of the downstream optical signals to detect a portion of the associated downstream optical signal. The subscriber units generate an associated one of the upstream optical signals, which is wavelength-locked by the remaining portion of the associated downstream optical signal, and output the associated upstream optical signal to the remote node.

### CLAIM OF PRIORITY

This application claims priority to an application entitled “BI-DIRECTIONAL OPTICAL ACCESS NETWORK” filed in the Korean Intellectual Property Office on May 20, 2004 and assigned Serial No. 2004-35846, the contents of which are hereby incorporated by reference.

### BACKGROUND OF THE INVENTION

1. Field of the Invention

The present invention relates to an optical access network, and more particularly to a bi-directional optical access network.

2. Description of the Related Art

Conventional communication networks using copper lines are being replaced with optical communication networks using optical fibers having superior characteristics. Such optical communication networks include a central office that provides data and a plurality of subscribers that receive the data. Based upon the distance between the central office and the subscribers, the optical communication network may be classified as an access network, a metro network, or a long-haul network. The optical communication network may also be classified into a wavelength division multiplexing system or a time division multiplexing system based upon the data transmission and reception method used.

In the wavelength division multiplexing (WDM) system, light having a predetermined wavelength band is demultiplexed into a plurality of channels respectively corresponding to different wavelengths in the predetermined wavelength band so that each of the channels is used to transmit and receive an optical signal modulated from data to be transmitted or received. This WDM system may use several light sources to directly generate an optical signal modulated from data, or a spectrum-sliced light source to demultiplex light of a broad wavelength band into a plurality of channels respectively corresponding to different wavelengths in the wavelength band, and to modulate the channels into optical signals, respectively.

Conventional spectrum-sliced light sources include an optical fiber amplifier or semiconductor optical amplifier to generate incoherent light, and a demultiplexer such as a WDM filter or arrayed-waveguide grating to demultiplex the generated light into a plurality of channels. In order to modulate data to be entrained in the demultiplexed channels, the spectrum-sliced light source must also include a plurality of external modulators. For the external modulators, LiNbO₃ modulators may be used.

In bi-directional communication, the above-mentioned optical signals may be sorted into downstream optical signals to be transmitted from the central office to respective subscribers, and upstream optical signals to be transmitted from respective subscribers to the central office. In order to minimize interference phenomena occurring therebetween, the downstream and upstream optical signals use different wavelength bands.

One shortcoming of the spectrum-sliced light source is that an expensive external modulator must be used. Furthermore, the light source that directly generates an optical signal modulated from data, may suffer from optical signal power degradation, and an increased generation of noise caused by the optical signal power degradation.

In order to solve the above-mentioned problems, a wavelength-locking light source has been proposed. The wavelength-locking light source includes a broadband light source that generates light having a broad wavelength band, a demultiplexer that demultiplexes the broadband light into sliced light beams having different wavelengths, and Fabry-Perot lasers that generates optical signals wavelength-locked by the sliced light beams, respectively. The broadband light is sliced into a plurality of light beams having different wavelengths which are, in turn, applied to respective Fabry-Perot lasers so that wavelength-locked optical signals are generated from respective Fabry-Perot lasers. In place of the Fabry-Perot lasers, semiconductor optical amplifiers may also be used.

The wavelength-locking light source can generate optical signals without using separate modulators. Also, the Fabry-Perot lasers can generate high-power optical signals because they are wavelength-locked by associated sliced light beams, respectively.

However, the wavelength-locking light source must use broadband light sources for the downstream optical signals and the upstream optical signals, respectively, in order to be applicable to a bi-directional optical access network. This is a problem because it increases installation costs of the network.

### SUMMARY OF THE INVENTION

One embodiment of the present invention is directed to a bi-directional optical access network including a central office that generates a plurality of wavelength-locked downstream optical signals, multiplexes the downstream optical signals, and outputs the resultant multiplexed signal. The network also includes a remote node that demultiplexes the multiplexed signal of the downstream optical signals output from the central office, outputs the demultiplexed downstream optical signals to subscriber units, respectively, multiplexes upstream optical signals, and outputs the resultant multiplexed signal of the upstream optical signals to the central office. The subscribers units each slice an associated one of the downstream optical signals to detect a portion of the associated downstream optical signal. Each of the subscriber units generate an associated one of the upstream optical signals, which is wavelength-locked by the remaining portion of the associated downstream optical signal, and output the associated upstream optical signal to the remote node.

Another embodiment of the present invention is directed to a bi-directional optical access network including a central office that generates a plurality of wavelength-locked downstream optical signals, multiplexes the downstream optical signals, and outputs the resultant multiplexed signal. The network also includes a remote node that demultiplexes the multiplexed signal of the downstream optical signals output from the central office, outputs the demultiplexed downstream optical signals to subscriber units, respectively, multiplexes upstream optical signals, and outputs the resultant multiplexed signal of the upstream optical signals to the central office. The subscriber units each detect an associated one of the downstream optical signals, generate an associated one of the upstream optical signals, which is wavelength-locked by the associated downstream optical signal, and output the associated upstream optical signal to the remote node. The network also includes a first optical fiber to link the central office and the remote node used to transmit the multiplexed signal of the downstream optical signals to the remote node, and to transmit the multiplexed signal of the upstream optical signals to the central office.

### BRIEF DESCRIPTION OF THE DRAWINGS

The above aspects and embodiments of the present invention will become more apparent by describing in detail embodiments thereof with reference to the attached drawings in which:

FIG. 1 is a block diagram illustrating a bi-directional optical access network according to a first embodiment of the present invention;

FIG. 2 is a block diagram illustrating a bi-directional optical access network according to a second embodiment of the present invention;

FIG. 3 is a block diagram illustrating a bi-directional optical access network according to a third embodiment of the present invention;

FIG. 4 is a block diagram illustrating a bidirectional optical access network according to a fourth embodiment of the present invention;

FIG. 5 is a block diagram illustrating a bi-directional optical access network according to a fifth embodiment of the present invention;

FIG. 6 is a block diagram illustrating a bi-directional optical access network according to a sixth embodiment of the present invention;

FIG. 7 is a block diagram illustrating a bi-directional optical access network according to a seventh embodiment of the present invention; and

FIG. 8 is a block diagram illustrating a bi-directional optical access network according to an eighth embodiment of the present invention.

### DETAILED DESCRIPTION

Now, embodiments of the present invention will be described in detail with reference to the annexed drawings. In the following description of the present invention, a detailed description of known functions and configurations incorporated herein will be omitted when it may obscure the subject matter of the present invention.

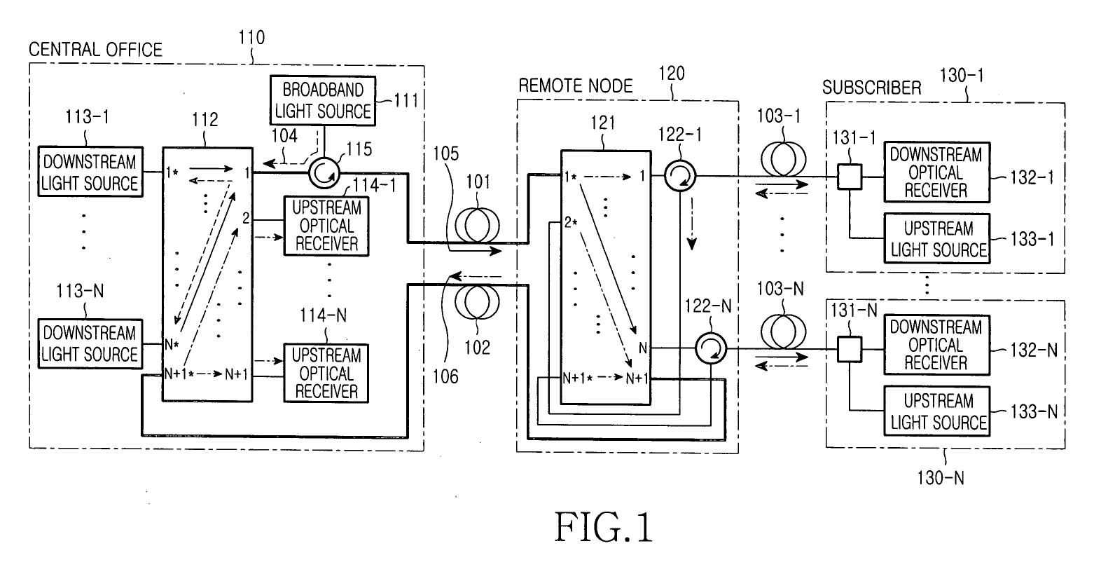

FIG. 1 is a block diagram illustrating a bi-directional optical access network according to a first embodiment of the present invention. The bi-directional optical access network includes a central office 110 that multiplexes a plurality of wavelength-locked downstream optical signals 105 and outputs the resultant multiplexed optical signal. The network also includes a remote node 120 that demultiplexes the multiplexed optical signal into the downstream optical signals 105, outputs the demultiplexed downstream optical signals 105 subscriber units 130-1 to 130-N, respectively, multiplexes upstream optical signals 106, and outputs the resultant multiplexed upstream optical signal to the central office 110. Each of the subscriber units 130-1 to 130-N output an associated one of the upstream optical signals 106 wavelength-locked by respective downstream optical signals 105 to the remote node 120. The central office 110 and remote node 120 are linked by a first optical fiber 101 and a second optical fiber 102. The remote node 120 is linked with the subscriber units 130-1 to 130-N by third optical fibers 103-1 to 103-N, respectively.

The first optical fiber 101 transmits the multiplexed signal of the downstream optical signals 105 from the central office 10 to the remote node 120. The second optical fiber 102 transmits the multiplexed signal of the upstream optical signals 106 from the remote node 120 to the central office 110. The third optical fibers 103-1 to 103-N, respectively, transmit the upstream optical signal 106 received from an associated one of the subscriber units 130-1 to 130-N to the remote node 120, and transmit an associated one of the downstream optical signals 105 output from the remote node 120 to the associated one of the subscriber units 130-1 to 130-N.

The central office 110 includes a broadband light source 111 that generates light 104 having a broad wavelength band, a first multiplexer/demultiplexer (MUX/DEMUX) 112 that demultiplexes the light 104 into a plurality of sliced light beams respectively corresponding to different wavelengths in the broad wavelength band, and a plurality of downstream light sources 113-1 to 113-N that generate the downstream optical signals 105 wavelength-locked by the sliced light beams demultiplexed in the first MUX/DEMUX 112, respectively. The central office 110 also includes a plurality of upstream optical receivers 114-1 to 114-N, and a first circulator 115. For the broadband light source 111, an optical fiber amplifier or semiconductor optical amplifier may be used that can generate incoherent light having a broad wavelength band.

The first MUX/DEMUX 112 multiplexes the downstream optical signals 105 generated in accordance with wavelength-locking operation carried out in respective downstream light sources 113-1 to 113-N, demultiplexes a multiplexed signal of the upstream optical signals 106 received from the remote node 106, and outputs the demultiplexed upstream optical signals 106 to the upstream optical receivers 114-1 to 114-N, respectively. Each of the upstream optical receivers 114-1 to 114-N detects an associated one of the demultiplexed upstream optical signals 106 output from the first MUX/DEMUX 112. For the upstream optical receivers 114-1 to 114-N, photodiodes may be used.

The first circulator 115 is arranged between the first MUX/DEMUX 112 and the first optical fiber 101, and is connected to the broadband light source 111. The first circulator 115 outputs the light 104 received from the broadband light source 111 to the first MUX/DEMUX 112, and outputs a multiplexed signal of the downstream optical signals 105 output from the first MUX/DEMUX 112 to the remote node 120 via the first optical fiber 101.

The remote node 120 includes a second MUX/DEMUX 121 linked to the central office 110 by the first optical fiber 101 and second optical fiber 102, and a plurality of second circulators 122-1 to 122-N that transmit the demultiplexed downstream optical signals 105 to the associated subscriber units 130-1 to 130-N, respectively.

The second circulators 122-1 to 122-N are arranged between an associated one of the subscriber units 130-1 to 130-N and the second MUX/DEMUX 121 that outputs an associated one of the demultiplexed downstream optical signals 105 to the associated subscriber unit. The second circulators 122-1 to 122-N also output the upstream optical signals 106 received from the associated subscriber units 130-1 to 130-N to the second MUX/DEMUX 121, respectively.

The second MUX/DEMUX 121 demultiplexes a multiplexed signal of the downstream optical signals 105 output from the central office 110, and outputs the demultiplexed downstream optical signals 105 to the second circulators 122-1 to 122-N, respectively. The second MUX/DEMUX 121 also multiplexes the upstream optical signals 106 respectively received from the second circulators 122-1 to 122-N, and outputs the resultant multiplexed signal to the central office 110.

For each of the first MUX/DEMUX 112 and second MUX/DEMUX 121, an arrayed waveguide grating or WDM filter may be used that has first through “N+1”-th ports at each of opposite ends thereof. For example, the first MUX/DEMUX 112 demultiplexes a multiplexed signal of the upstream optical signals 106 input to the “N+1”-th port of the first end thereof in accordance with different wavelengths, and outputs the demultiplexed upstream optical signals 106 to the second to “N+1”-th ports of the second end thereof, respectively. The first MUX/DEMUX 112 also multiplexes the downstream optical signals 105 respectively input to the first through N-th ports of the first end thereof, and outputs the resultant multiplexed signal to the first circulator 115 through the first port of the second end.

The subscriber units 130-1 to 130-N include respective downstream optical receivers 132-1 to 132-N that detect an associated one of the downstream optical signals 105, respective upstream light sources 133-1 to 133-N that generate the upstream optical signal 106 wavelength-locked by an associated one of the downstream optical signals 105, and respective light intensity splitters 131-1 to 131-N.

The light intensity splitters 131-1 to 131-N split the downstream optical signal 105 received from an associated one of the third optical fibers 103-1 to 103-N and output a portion of the downstream optical signal 105 to an associated one of the downstream optical receivers 132-1 to 132-N and to output the remaining portion of the downstream optical signal 105 to an associated one of the upstream light sources 133-1 to 133-N. The light intensity splitters 131-1 to 131-N also transmit the upstream optical signal 106 generated from the associated one of the upstream light sources 133-1 to 133-N to the remote node 120 via an associated one of the third optical fibers 103-1 to 103-N.

For the downstream light sources 113-1 to 133-N and upstream light sources 133-1 to 133-N, Fabry-Perot lasers or semiconductor lasers may be used. Such Fabry-Perot lasers and semiconductor layers can generate optical signals without using separate modulators.

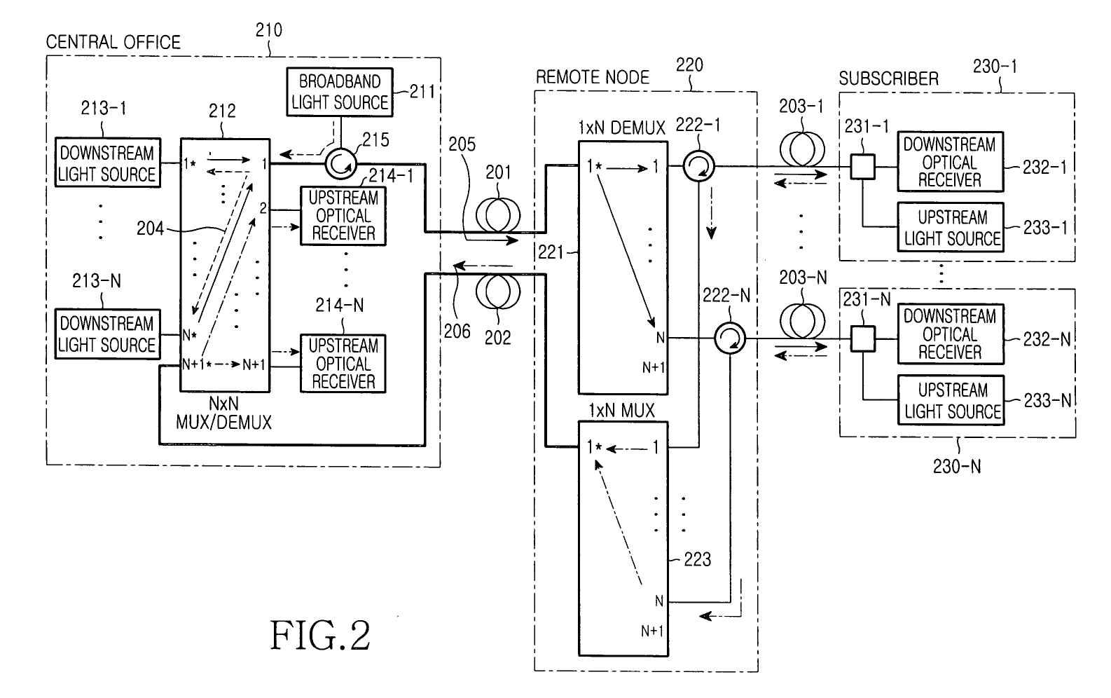

FIG. 2 is a block diagram illustrating a bi-directional optical access network according to a second embodiment of the present invention. The bi-directional optical access network includes a central office 210, a remote node 220, a plurality of subscriber units 230-1 to 230-N, a first optical fiber 201 and a second optical fiber 202 to link the central office 210 and remote node 220, and a plurality of third optical fibers 203-1 to 203-N that link the remote node 210 and an associated one of the subscriber units 230-1 to 230-N.

The central office 210 includes a broadband light source 211 that generate light 204 having a broad wavelength band, a first MUX/DEMUX 212 to demultiplex the light 204 into a plurality of sliced light beams respectively corresponding to different wavelengths in the broad wavelength band, and a plurality of downstream light sources 213-1 to 213-N that generate the downstream optical signals 105 wavelength-locked by the sliced light beams demultiplexed in the first MUX/DEMUX 212, respectively. The central office 210 also includes a plurality of upstream optical receivers 214-1 to 214-N and a first circulator 215.

The remote node 220 includes a DEMUX 221, a MUX 223, and a plurality of second circulators 222-1 to 222-N. The DEMUX 221 demultiplexes a multiplexed signal of the downstream optical signals 205 received from the central office 210 via the first optical fiber 201, and outputs the demultiplexed optical signals 205 to the associated subscriber units 230-1 to 230-N, respectively. The MUX 223 multiplexes the upstream optical signals 206 received from the subscriber units 230-1 to 230-N, and outputs the resultant multiplexed signal to the central office 210 via the second optical fiber 202.

The second circulators 222-1 to 222-N output an associated one of the demultiplexed downstream optical signals 205 to the associated subscriber unit via an associated one of the third optical fibers 203-1 to 203-N. The second circulators 222-1 to 222-N also output the upstream optical signals 206 received from the associated subscriber units 230-1 to 230-N to the MUX 223, respectively.

The subscriber units 230-1 to 230-N include respective downstream optical receivers 232-1 to 232-N that detect the associated downstream optical signals 205, respective upstream light sources 233-1 to 233-N that generate the upstream optical signals 206 respectively wavelength-locked by the associated downstream optical signals 205, and respective light intensity splitters 231-1 to 231-N that split the downstream optical signal 105 received from an associated one of the third optical fibers 203-1 to 203-N and output a portion of the downstream optical signal 205 to an associated one of the downstream optical receivers 232-1 to 232-N and output the remaining portion of the downstream optical signal 105 to an associated one of the upstream light sources 233-1 to 233-N.

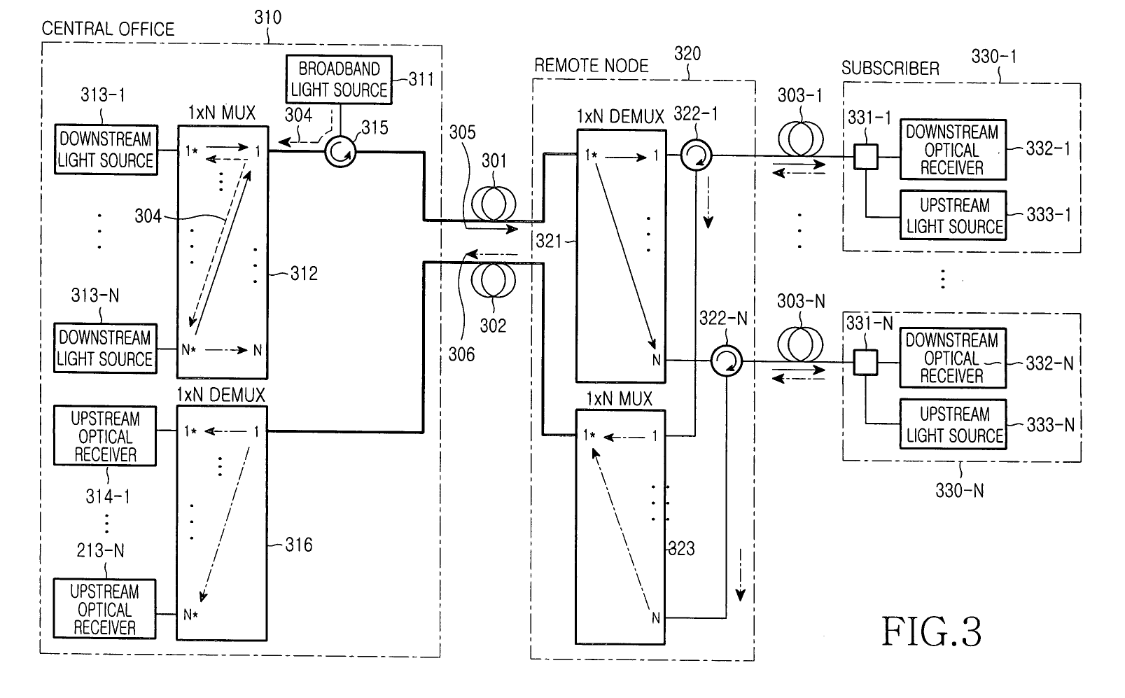

FIG. 3 is a block diagram illustrating a bidirectional optical access network according to a third embodiment of the present invention. The bi-directional optical access network includes a central office 310 that generates a multiplexed signal of downstream optical signals 305, a remote node 320 that multiplexes upstream optical signals 306, a plurality of subscriber units 330-1 to 330-N, a first optical fiber 301 and a second optical fiber 302 linking the central office 310 and remote node 320, and a plurality of third optical fibers 303-1 to 303-N linking the remote node 320 and an associated one of the subscriber units 330-1 to 330-N.

The central office 310 includes a broadband light source 311 that generates light 304 of a broad wavelength band, a plurality of downstream light sources 313-1 to 313-N that generate the downstream optical signals 305, which are wavelength-locked, and a first MUX 312 that multiplexes the downstream optical signals 305. The central office 310 also includes a first DEMUX 316 that demultiplexes a multiplexed signal of the upstream optical signals 306, a plurality of upstream optical receivers 314-1 to 314-N that detect the demultiplexed upstream optical signals 306, respectively, and a first circulator 315.

The first MUX 312 outputs the multiplexed signal of the downstream optical signals 305 to the first circulator 315. The first MUX 312 also slices the light 304 generated from the broadband light source 311 into a plurality of sliced light beams respectively corresponding to different wavelengths in the broad wavelength band, and outputs the sliced light beams to the associated downstream light sources 313-1 to 313-N. The downstream light sources 313-1 to 313-N generate the associated downstream optical signal 305 wavelength-locked by the associated sliced light.

The first DEMUX 316 demultiplexes the multiplexed signal of the upstream optical signals 306 received via the second optical fiber 302, and outputs the demultiplexed upstream optical signals 306 to the associated upstream optical receivers 314-1 to 314-N, respectively. The upstream optical receivers 314-1 to 314-N detect the associated upstream optical signals 306 demultiplexed in the first DEMUX 316.

The first circulator 315 is connected to the broadband light source 311 between the first MUX 312 and the first optical fiber 301 to output the light 304 to the first MUX 312, and to output the multiplexed signal of the downstream optical signals 305 output from the first MUX 312 to the remote node 320 via the first optical fiber 301.

The remote node 320 includes a second DEMUX 321, a second MUX 323, and a plurality of second circulators 322-1 to 322-N. The second DEMUX 321 demultiplexes the multiplexed signal of the downstream optical signals 305 received from the first optical fiber 301, and outputs the demultiplexed downstream optical signals 305 to the associated subscriber units 330-1 to 330-N, respectively. The second MUX 323 multiplexes the upstream optical signals 306 received from respective subscriber units 330-1 to 330-N, and outputs the multiplexed signal of the upstream optical signals 306 to the first DEMUX 316 via the second optical fiber 302.

The second circulators 322-1 to 322-N output an associated one of the downstream optical signals 305 demultiplexed in the second DEMUX 321 to an associated one of the subscriber units 330-1 to 330-N. The second circulators 322-1 to 322-N also output the upstream optical signals 306 received from the associated subscribers 330-1 to 330-N to the second MUX 323, respectively.

The subscriber units 330-1 to 330-N include respective downstream optical receivers 332-1 to 332-N that detect the associated downstream optical signals 305, respective upstream light sources 333-1 to 333-N that generate the upstream optical signals 306 respectively wavelength-locked by the associated downstream optical signals 305, and respective light intensity splitters 331-1 to 331-N that split the downstream optical signal 305 received from an associated one of the third optical fibers 303-1 to 303-N to output a portion of the downstream optical signal 305 to an associated one of the downstream optical receivers 332-1 to 332-N and to output the remaining portion of the downstream optical signal 305 to an associated one of the upstream light sources 333-1 to 333-N.

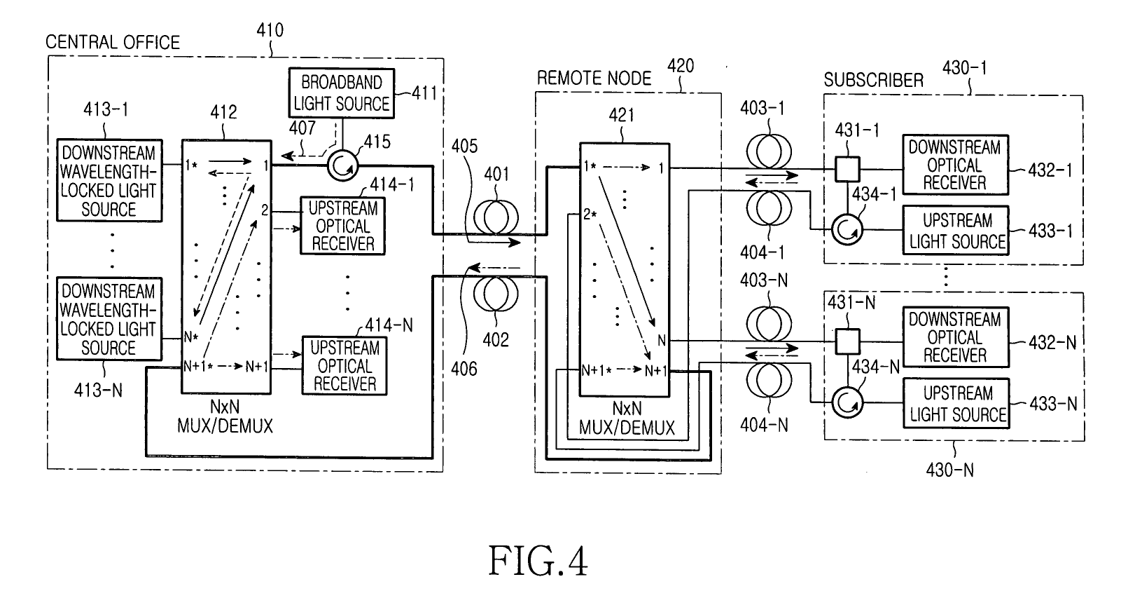

FIG. 4 is a block diagram illustrating a bi-directional optical access network according to a fourth embodiment of the present invention. The bi-directional optical access network includes a central office 410 that generates downstream optical signals 405, a remote node 420, a plurality of subscriber units 430-1 to 430-N that generate upstream optical signals 406, a first optical fiber 401 and a second optical fiber 402 linking the central office 410 and remote node 420, and a plurality of third optical fibers 403-1 to 403-N and a plurality of fourth optical fibers 404-1 to 404-N. The third optical fibers 403-1 to 403-N and an associated one of the fourth optical fibers 404-1 to 404-N link the remote node 420 and an associated one of the subscriber units 430-1 to 430-N.

The central office 410 includes a broadband light source 411 that generates light 407 having a broad wavelength band, a first MUX/DEMUX 412 that demultiplexes the light 407 into a plurality of sliced light beams respectively corresponding to different wavelengths in the broad wavelength band, and a plurality of downstream light sources 413-1 to 413-N that generate the downstream optical signals 405 wavelength-locked by the sliced light beams, respectively. The central office 410 also includes a plurality of upstream optical receivers 414-1 to 414-N, and a first circulator 415.

The first MUX/DEMUX 412 multiplexes the downstream optical signals 405, demultiplexes a multiplexed signal of the upstream optical signals 406, and outputs the demultiplexed upstream optical signals 406 to the upstream optical receivers 414-1 to 414-N, respectively.

The first circulator 415 is arranged between the first MUX/DEMUX 412 and the first optical fiber 401, and is connected to the broadband light source 411. The first circulator 415 outputs the light 407 to the first MUX/DEMUX 412, and outputs a multiplexed signal of the downstream optical signals 405 output from the first MUX/DEMUX 412 to the remote node 420 via the first optical fiber 401.

The remote node 420 includes a second MUX/DEMUX 421. The second MUX/DEMUX 421 demultiplexes the multiplexed signal of the downstream optical signals 405, and outputs the demultiplexed downstream optical signals 405 to the subscriber units 430-1 to 430-N, respectively. The second MUX/DEMUX 421 also multiplexes the upstream optical signals 406 received from the subscribers 430-1 to 430-N, and outputs the multiplexed signal of the upstream optical signals 406 to the first MUX/DEMUX 412 via the second optical fiber 402.

The subscriber units 430-1 to 430-N include light intensity splitters 431-1 to 431-N respectively linked to the second MUX/DEMUX 421 by the third optical fibers 403-1 to 403-N, second circulators 434-1 to 434-N respectively linked to the second MUX/DEMUX 421 by the fourth optical fibers 404-1 to 404-N, and upstream light sources 433-1 to 433-N to generate the upstream optical signals 406 wavelength-locked by the associated downstream optical signals 405, respectively.

The light intensity splitters 431-1 to 431-N split the downstream optical signal 405 received from an associated one of the third optical fibers 403-1 to 403-N to output a portion of the downstream optical signal 105 to an associated one of the second circulators 434-1 to 434-N and to output the remaining portion of the downstream optical signal 105 to an associated one of the downstream optical receivers 432-1 to 432-N. The downstream optical receivers 432-1 to 432-N detect the associated downstream optical signal 405.

The upstream light sources 433-1 to 433-N generate the upstream optical signals 406 wavelength-locked by the downstream optical signals 405 received from the second circulators 434-1 to 434-N, respectively, and output the generated upstream optical signals 406 to the fourth optical fibers 434-1 to 434-N via the second circulators 434-1 to 434-N, respectively.

The second circulators 434-1 to 434-N are connected to an associated one of the light intensity splitters 431-1 to 431-N, an associated one of the upstream light sources 433-1 to 433-N, and an associated one of the fourth optical fibers 404-1 to 404-N. The second circulators 434-1 to 434-N output the associated wavelength-locked upstream optical signal 406 to the remote node 420 via an associated one of the fourth optical fibers 404-1 to 404-N, and output the downstream optical signal 405 received from an associated one of the light intensity splitters 431-1 to 431-N to an associated one of the upstream light sources 433-1 to 433-N.

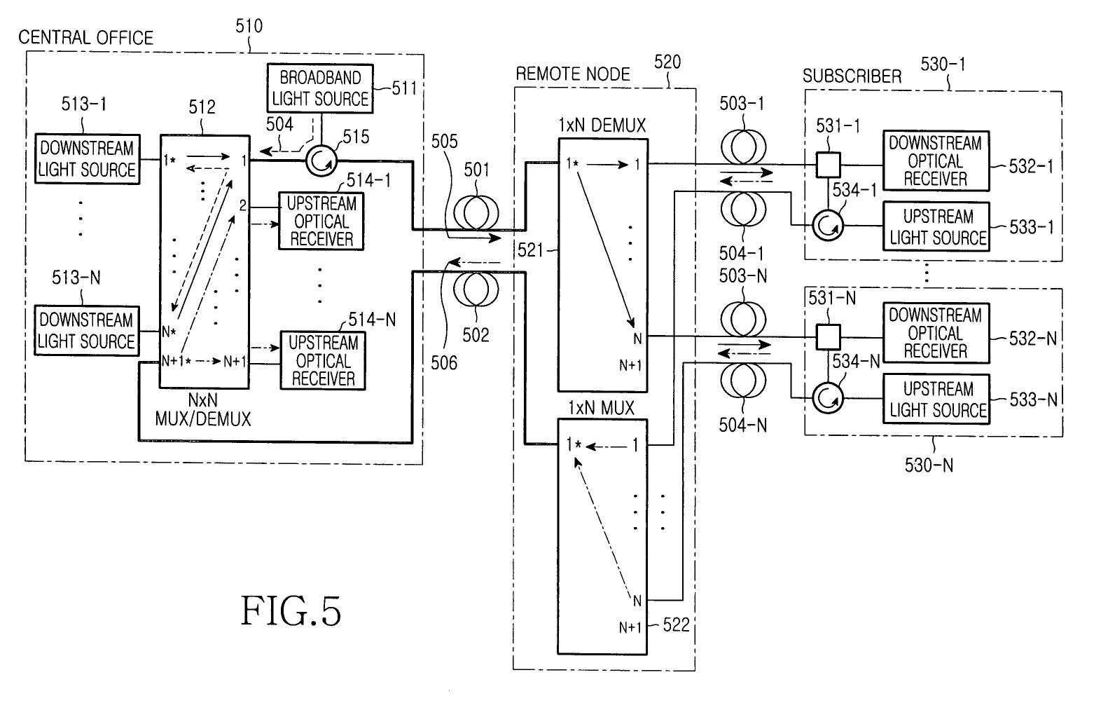

FIG. 5 is a block diagram illustrating a bi-directional optical access network according to a fifth embodiment of the present invention. The bi-directional optical access network includes a central office 510 that generates downstream optical signals 505, a remote node 520, and a plurality of subscriber units 530-1 to 530-N that generate upstream optical signals 506. The bi-directional optical access network also includes a first optical fiber 501 and a second optical fiber 502 linking the central office 510 and remote node 520, and a plurality of third optical fibers 503-1 to 503-N and a plurality of fourth optical fibers 504-1 to 504-N. The third optical fibers 503-1 to 503-N and an associated one of the fourth optical fibers 504-1 to 504-N link the remote node 520 and an associated one of the subscriber units 530-1 to 530-N.

The central office 510 includes a broadband light source 511 that generates light 504 having a broad wavelength band, a MUX/DEMUX 512 that demultiplexes the light 504 into a plurality of sliced light beams respectively corresponding to different wavelengths in the broad wavelength band. The central office 510 also includes a plurality of downstream light sources 513-1 to 513-N that generate the downstream optical signals 505 wavelength-locked by the sliced light beams demultiplexed in the MUX/DEMUX 512, respectively, a plurality of upstream optical receivers 514-1 to 514-N to detect the upstream optical signals, respectively, and a first circulator 515.

The remote node 520 includes a DEMUX 521, and a MUX 522. The DEMUX 521 demultiplexes a multiplexed signal of the downstream optical signals 505 received via the first optical fiber 501, and outputs the demultiplexed downstream optical signals 505 to the subscriber units 530-1 to 530-N via the third optical fibers 503-1 to 503-N, respectively. The MUX 522 multiplexes the upstream optical signals 506 respectively received via the fourth optical fibers 504-1 to 504-N, and outputs the resultant multiplexed signal of the upstream optical signals 506 to the central office 510 via the second optical fiber 502.

The subscriber units 530-1 to 530-N include light intensity splitters 531-1 to 531-N respectively linked to the DEMUX 521 by the third optical fibers 503-1 to 503-N, second circulators 534-1 to 534-N respectively linked to the MUX 522 by the fourth optical fibers 504-1 to 504-N, downstream optical receivers 532-1 to 532-N, and upstream light sources 533-1 to 533-N to generate the upstream optical signals 506 wavelength-locked by the associated downstream optical signals 505, respectively.

The light intensity splitters 531-1 to 531-N split the downstream optical signal 505 received from an associated one of the third optical fibers 503-1 to 503-N to output a portion of the downstream optical signal 505 to an associated one of the second circulators 534-1 to 534-N and to output the remaining portion of the downstream optical signal 505 to an associated one of the downstream optical receivers 532-1 to 532-N. The downstream optical receivers 532-1 to 532-N detect the associated downstream optical signal 505.

The upstream light sources 533-1 to 533-N generate the upstream optical signals 506 wavelength-locked by the downstream optical signals 505 received from the second circulators 534-1 to 534-N, respectively, and output the generated upstream optical signals 506 to the second circulators 534-1 to 534-N, respectively. The second circulators 534-1 to 534-N are connected to an associated one of the light intensity splitters 531-1 to 531-N, an associated one of the upstream light sources 533-1 to 533-N, and an associated one of the fourth optical fibers 504-1 to 504-N.

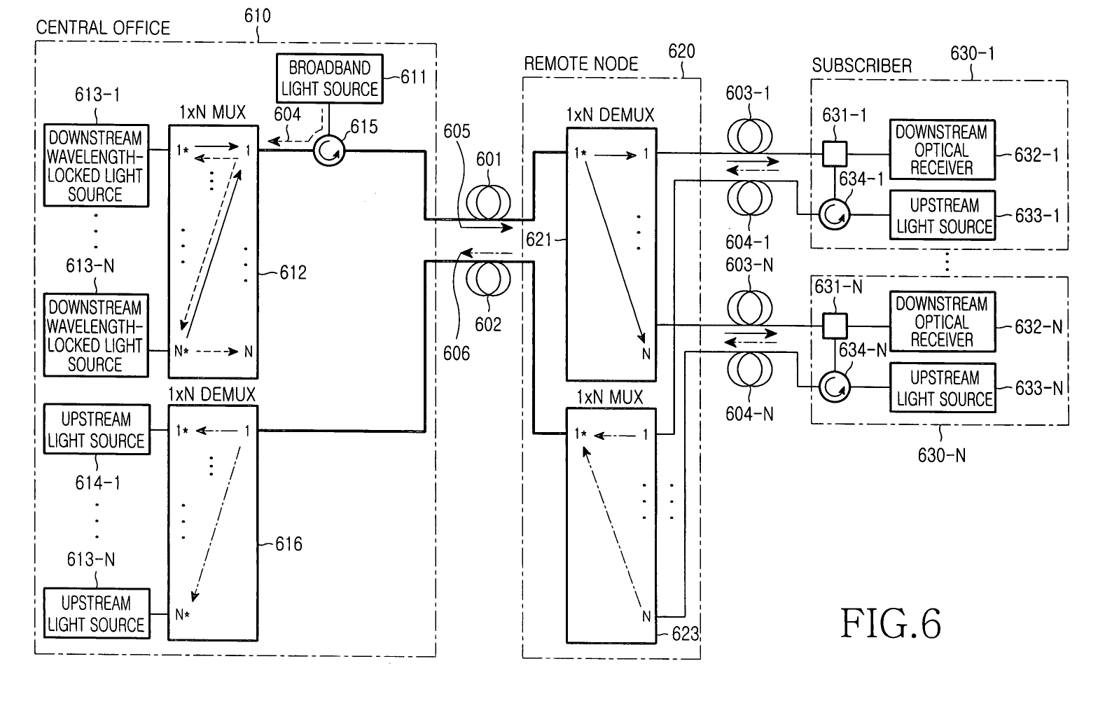

FIG. 6 is a block diagram illustrating a bi-directional optical access network according to a six embodiment of the present invention. The bi-directional optical access network includes a central office 610 that generates downstream optical signals 605, a remote node 620, a plurality of subscriber units 630-1 to 630-N that generate upstream optical signals 606, respectively, a first optical fiber 601 and a second optical fiber 602 to link the central office 610 and remote node 620, and a plurality of third optical fibers 603-1 to 603-N and a plurality of fourth optical fibers 604-1 to 604-N. The third optical fibers 603-1 to 603-N and an associated one of the fourth optical fibers 604-1 to 604-N link the remote node 620 and an associated one of the subscriber units 630-1 to 630-N.

The central office 610 includes a broadband light source 611 that generates light 604 having a broad wavelength band, and a plurality of downstream light sources 613-1 to 613-N that generate the downstream optical signals 605, which are wavelength-locked. The central office 610 also includes a first MUX 612 that multiplexes the downstream optical signals 605, a first DEMUX 616 that demultiplexes a multiplexed signal of the upstream optical signals 606, a plurality of upstream optical receivers 614-1 to 614-N that detect the demultiplexed upstream optical signals 606, respectively, and a first circulator 615.

The first MUX 612 outputs the multiplexed signal of the downstream optical signals 605 to the first optical fiber 601. The first MUX 612 also slices the light 604 generated from the broadband light source 611 into a plurality of sliced light beams respectively corresponding to different wavelengths in the broad wavelength band, and outputs the sliced light beams to the associated downstream light sources 613-1 to 613-N.

The first DEMUX 616 demultiplexes the multiplexed signal of the upstream optical signals 606 received via the second optical fiber 602, and outputs the demultiplexed upstream optical signals 606 to the associated upstream optical receivers 614-1 to 614-N, respectively. The upstream optical receivers 614-1 to 614-N detect the associated upstream optical signals 606 demultiplexed in the first DEMUX 616.

The first circulator 615 is arranged between the first MUX 612 and the first optical fiber 601, and is connected to the broadband light source 611.

The remote node 620 includes a second DEMUX 621 and a second MUX 623. The second DEMUX 621 demultiplexes the multiplexed signal of the downstream optical signals 605 received from the first optical fiber 601, and outputs the demultiplexed downstream optical signals 605 to the associated subscribers 630-1 to 630-N, respectively. The second MUX 623 multiplexes the upstream optical signals 606 received from respective subscribers 630-1 to 630-N, and outputs the multiplexed signal of the upstream optical signals 606 to the first DEMUX 616 via the second optical fiber 602.

The subscriber units 630-1 to 630-N include light intensity splitters 631-1 to 631-N respectively linked to the remote node 620 by the third optical fibers 603-1 to 603-N, second circulators 634-1 to 634-N respectively linked to the remote node 620 by the fourth optical fibers 604-1 to 604-N, and upstream light sources 633-1 to 633-N that generate the upstream optical signals 606 wavelength-locked by the associated downstream optical signals 605, respectively.

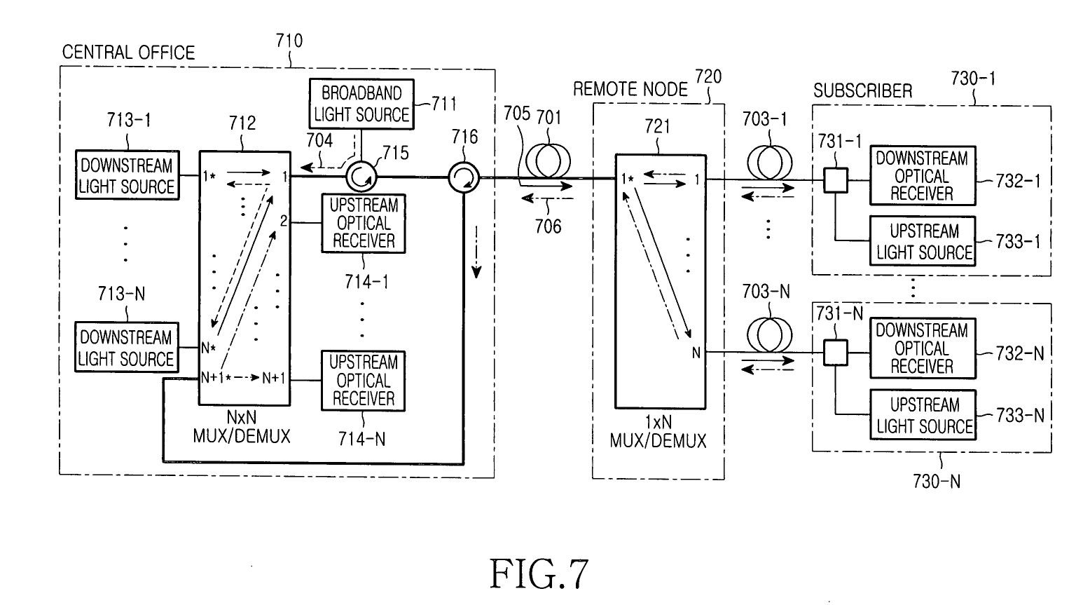

FIG. 7 is a block diagram illustrating a bi-directional optical access network according to a seventh embodiment of the present invention. The bi-directional optical access network includes a central office 710 that generates downstream optical signals 705, a remote node 720, and a plurality of subscriber units 730-1 to 730-N that generate upstream optical signals 706. The bi-directional optical access network also includes a first optical fiber 701 linking the central office 710 and remote node 720, and a plurality of second optical fibers 703-1 to 703-N linking the remote node 720 and an associated one of the subscriber units 730-1 to 730-N.

The first optical fiber 701 transmits a multiplexed signal of the downstream optical signals 705 from the central office 710 to the remote node 720, and transmits a multiplexed signal of the upstream optical signals 706 from the remote node 720 to the central office 710. The second optical fibers 703-1 to 703-N transmit an associated one of the downstream optical signals 705 demultiplexed in the remote node 720 to the associated one of the subscriber units 730-1 to 730-N, and transmits the upstream optical signal 706 generated from the associated one of the subscriber units 730-1 to 730-N to the remote node 720.

The central office 710 includes a broadband light source 711 that generates light 704 of a broad wavelength band, a first MUX/DEMUX 712 that demultiplexes the light 704 into a plurality of sliced light beams respectively corresponding to different wavelengths in the broad wavelength band, and a plurality of downstream light sources 713-1 to 713-N that generate the downstream optical signals 705 wavelength-locked by the sliced light beams, respectively. The central office 710 also includes a plurality of upstream optical receivers 714-1 to 714-N, a first circulator 715, and a second circulator 716. The second circulator 716 outputs the multiplexed signal of the upstream optical signals 706 to the first MUX/DEMUX 712. The first circulator 715 outputs the multiplexed signal of the downstream optical signals 705 to the second circulator 716.

The first circulator 715 is arranged between the first MUX/DEMUX 712 and the second circulator 716, and is connected to the broadband light source 711. The second circulator 716 is arranged between the first optical fiber 701 and the first circulator 715 to output the multiplexed signal of the upstream optical signals 706 received via the first optical fiber 701 to the first MUX/DEMUX 712, and to output the multiplexed signal of the downstream optical signals 705 received from the first circulator 715 to the remote node 720 via the first optical fiber 701.

The first MUX/DEMUX 712 multiplexes the downstream optical signals 705 generated from respective downstream light sources 713-1 to 713-N, and outputs the multiplexed signal of the downstream optical signals 705 to the first circulator 715. The first MUX/DEMUX 712 also demultiplexes the multiplexed signal of the upstream optical signals 706 received from the second circulator 716, and outputs the demultiplexed upstream optical signals 706 to the upstream optical receivers 714-1 to 714-N, respectively.

The upstream optical receivers 714-1 to 714-N detect an associated one of the demultiplexed upstream optical signals 706 output from the first MUX/DEMUX 712.

The remote node 720 demultiplexes the multiplexed signal of the downstream optical signals 705, and the demultiplexed downstream optical signals 705 to the subscriber units 730-1 to 730-N, respectively. The remote node 720 also multiplexes the upstream optical signals 706 respectively received from the subscriber units 730-1 to 730-N, and outputs the resultant multiplexed signal of the upstream optical signals 706 to the central office 710.

The subscriber units 730-1 to 730-N include respective downstream optical receivers 732-1 to 732-N that detect an associated one of the downstream optical signals 705, respective upstream light sources 733-1 to 733-N that generate the upstream optical signal 706 wavelength-locked by an associated one of the downstream optical signals 705, and respective light intensity splitters 731 -1 to 731-N.

The light intensity splitters 731-1 to 731-N are linked to the remote node 720 by an associated one of the second optical fibers 703-1 to 703-N to receive an associated one of the downstream optical signals 705 from the remote node 720. The light intensity splitters 731-1 to 731-N split the associated downstream optical signal 705 to output a portion of the downstream optical signal 705 to an associated one of the downstream optical receivers 732-1 to 732-N and to output the remaining portion of the downstream optical signal 705 to an associated one of the upstream light sources 733-1 to 733-N. Each of the light intensity splitters 731-1 to 731-N also transmits the upstream optical signal 106 generated from the associated one of the upstream light sources 733-1 to 733-N to the remote node 720 via an associated one of the second optical fibers 703-1 to 703-N.

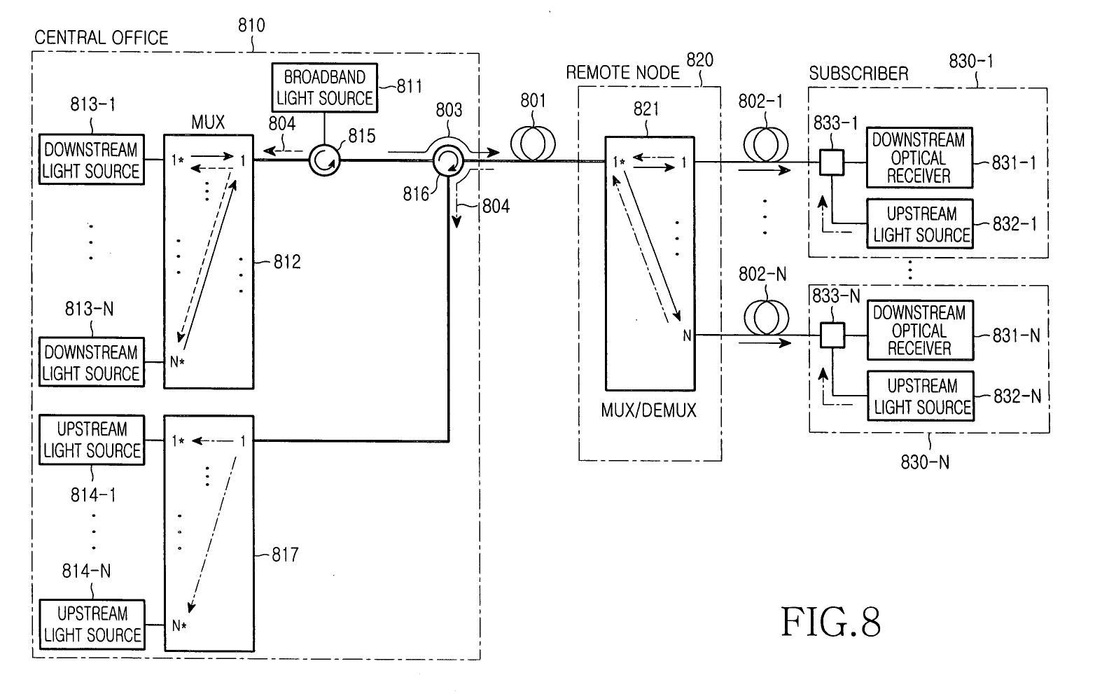

FIG. 8 is a block diagram illustrating a bi-directional optical access network according to an eighth embodiment of the present invention. The bi-directional optical access network includes a central office 810 that generates downstream optical signals 803, a plurality of subscriber units 830-1 to 830-N to generate upstream optical signals 805, respectively, a remote node 820 that multiplexes the upstream optical signals 805, a first optical fiber 801 linking the central office 810 and remote node 820, and a plurality of second optical fibers 802-1 to 802-N linking the remote node 820 and an associated one of the subscriber units 830-1 to 830-N.

The first optical fiber 801 transmits a multiplexed signal of the downstream optical signals 803 from the central office 810 to the remote node 820, and transmits a multiplexed signal of the upstream optical signals 805 from the remote node 820 to the central office 810. The second optical fibers 802-1 to 802-N transmit an associated one of the downstream optical signals 803 demultiplexed in the remote node 820 to the associated one of the subscriber units 830-1 to 830-N, and transmits the upstream optical signal 805 generated from the associated one of the subscriber units 830-1 to 830-N to the remote node 820.

The central office 810 includes a broadband light source 811 that generates light 804 having a broad wavelength band, and a plurality of downstream light sources 813-1 to 813-N that generate the downstream optical signals 803, which are wavelength-locked. The central office 810 also includes a MUX 812 that multiplexes the downstream optical signals 803, a DEMUX 817 that demultiplexes a multiplexed signal of the upstream optical signals 805, a plurality of upstream optical receivers 814-1 to 814-N that detect the demultiplexed upstream optical signals 805, respectively. The central office 810 also includes a first circulator 815 and a second circulator 816. The second circulator 816 outputs the multiplexed signal of the upstream optical signals 805 to the DEMUX 817. The first circulator 815 outputs the multiplexed signal of the downstream optical signals 803 to the second circulator 816.

The MUX 812 also multiplexes the downstream optical signals 803 generated from respective downstream light sources 813-1 to 813-N, and to output the resultant multiplexed signal to the first circulator 815.

The first circulator 815 is arranged between the MUX 812 and the second circulator 816, and is connected to the broadband light source 811. The second circulator 816 is arranged between the first optical fiber 801 and the first circulator 815 to output the multiplexed signal of the upstream optical signals 805 received via the first optical fiber 801 to the DEMUX 817, and to output the multiplexed signal of the downstream optical signals 803 received from the first circulator 815 to the remote node 820 via the first optical fiber 801.

The remote node 820 includes a MUX/DEMUX 821 that demultiplexes the multiplexed signal of the downstream optical signals 803, outputs the demultiplexed downstream optical signals 803 to the subscriber units 830-1 to 830-N, respectively, multiplexes the upstream optical signals 805 received from respective subscriber units 830-1 to 830-N, and outputs the multiplexed signal of the upstream optical signals 805 to the central office 810.

The subscriber units 830-1 to 830-N include respective downstream optical receivers 831-1 to 831-N that detect an associated one of the downstream optical signals 803, respective upstream light sources 832-1 to 832-N that generate the upstream optical signal 805 wavelength-locked by an associated one of the downstream optical signals 803, and respective light intensity splitters 833-1 to 833-N.

The light intensity splitters 833-1 to 833-N are linked to the remote node 820 by an associated one of the second optical fibers 802-1 to 802-N to receive an associated one of the downstream optical signals 803 from the remote node 820. The light intensity splitters 833-1 to 833-N split the associated downstream optical signal 803 to output a portion of the downstream optical signal 803 to an associated one of the downstream optical receivers 831-1 to 831-N and to output the remaining portion of the downstream optical signal 803 to an associated one of the upstream light sources 832-1 to 832-N. The light intensity splitters 833-1 to 833-N also transmit the upstream optical signal 805 generated from the associated one of the upstream light sources 832-1 to 832-N to the remote node 820 via an associated one of the second optical fibers 802-1 to 802-N.

As described in various embodiments above, downstream and upstream optical signals of the same wavelength band can be used by linking the central office and remote node by two independent optical fibers while setting different data modulation rates for the downstream and upstream optical signals. This structure allows for an increase in the number of lines in accordance with the use of downstream and upstream optical signals of the same wavelength band.

Of course, in the case of a bi-directional passive optical access network in which a central office and a remote node are linked by a single optical fiber, noise may be generated due to interference between downstream and upstream signals. However, various embodiments of the present invention are effectively applicable to optical access networks having a transmission length of 10 km or less, which is a short-distance communication network. It is possible to easily achieve an expansion of usable wavelength band in accordance with use of downstream and upstream optical signals of the same wavelength band. In addition, it is possible to easily construct the system and to reduce manufacturing costs because it is unnecessary to use a separate broadband light source for subscriber units.

While this invention has been described in connection with what is presently considered to be the most practical and preferred embodiments, it is to be understood that the invention is not limited to the disclosed embodiments, but, on the contrary, it is intended to cover various modifications within the spirit and scope of the appended claims.

1. A bi-directional optical access network comprising:
a central office that generates a plurality of wavelength-locked downstream optical signals, multiplexes the downstream optical signals, and outputs the resultant multiplexed signal; and
a remote node that demultiplexes the multiplexed signal of the downstream optical signals output from the central office, outputs the demultiplexed downstream optical signals to a plurality of subscriber units, respectively, multiplexes upstream optical signals, and outputs the resultant multiplexed signal of the upstream optical signals to the central office,
wherein the plurality of subscriber units slices an associated one of the downstream optical signals to detect a portion of the associated downstream optical signal, the plurality of subscribers generate an associated one of the upstream optical signals, which is wavelength-locked by the remaining portion of the associated downstream optical signal, and output the associated upstream optical signal to the remote node.

2. The bi-directional optical access network according to claim 1, further comprising:
a first optical fiber linked between the central office and the remote node that is used to transmit the multiplexed signal of the downstream optical signals to the remote node; and
a second optical fiber linked between the central office and the remote node that is used to transmit the multiplexed signal of the upstream optical signals to the central office.

3. The bi-directional optical access network according to claim 1, further comprising:
a plurality of third optical fibers linked between the remote node and an associated one of the subscriber units that are used to transmit the upstream optical signal generated from the associated subscriber unit to the remote node, and to transmit an associated one of the demultiplexed downstream optical signals output from the remote node to the associated subscriber unit.

4. The bi-directional optical access network according to claim 1, further comprising:
a plurality of third optical fibers linked between the remote node and an associated one of the subscriber units that are used to transmit an associated one of the demultiplexed downstream optical signals output from the remote node to the associated subscriber unit; and
a plurality of fourth optical fibers linked between the remote node and an associated one of the subscriber units that are used to transmit the upstream optical signal generated from the associated subscriber unit to the remote node.

5. The bi-directional optical access network according to claim 1, wherein the central office comprises:
a broadband light source that generates light having a broad wavelength band;
a first multiplexer/demultiplexer (MUX/DEMUX) that multiplexes the downstream optical signals, outputs the multiplexed signal of the downstream optical signals, demultiplexes the multiplexed upstream optical signals, and demultiplexes the light into a plurality of sliced light beams respectively corresponding to different wavelengths in the broad wavelength band; and
a plurality of downstream optical light sources that generate the downstream optical signals, which are wavelength-locked by the sliced light beams demultiplexed in the first MUX/DEMUX.

6. The bi-directional optical access network according to claim 5, wherein the central office further comprises:
a plurality of upstream optical receivers that detect the multiplexed upstream optical signals output from the first MUX/DEMUX; and
a fist circulator that outputs the light generated from the broadband light source to the first MUX/DEMUX, and outputs the multiplexed signal of the downstream optical signals output from the first MUX/DEMUX to the remote node.

7. The bi-directional optical access network according to claim 2, wherein the remote node comprises:
a second multiplexer/demultiplexer (MUX/DEMUX), linked to the central office by the first and second optical fibers, that demultiplexes the multiplexed signal of the downstream optical signals output from the central office, outputs the demultiplexed downstream optical signals to the subscriber units, respectively, multiplexes the upstream optical signals respectively outputfrom the subscriber units, and outputs the resultant multiplexed signal of the upstream optical signals to the central office.

8. The bi-directional optical access network according to claim 7, wherein the remote node further comprises:
a plurality of second circulators arranged between an associated one of the subscriber units and the second MUX/DEMUX to output an associated one of the demultiplexed downstream optical signals to the associated subscriber unit, and to output the upstream optical signal from the associated subscriber unit to the second MUX/DEMUX.

9. The bi-directional optical access network according to claim 1, wherein the remote node comprises:
a demultiplexer that demultiplexes the multiplexed signal of the downstream optical signals received via the first optical fiber, and outputs the demultiplexed downstream optical signals to the subscriber units, respectively; and
a multiplexer that multiplexes the upstream optical signals, and output the resultant multiplexed signal of the upstream optical signals to the central office via the second optical fiber.

10. The bi-directional optical access network according to claim 9, wherein the remote node further comprises:
a plurality of second circulators that output an associated one of the demultiplexed downstream optical signals output from the demultiplexer to an associated one of the subscriber units, and output the upstream optical signal from the associated subscriber unit to the multiplexer.

11. The bi-directional optical access network according to claim 1, wherein the central office comprises:
a broadband light source that generates light having a broad wavelength band;
a first multiplexer that slices the light generated from the broadband light source into a plurality of sliced light beams respectively corresponding to different wavelengths in the broad wavelength band, multiplexes the downstream optical signals, outputs the multiplexed signal of the downstream optical signals to the first optical fiber;
a plurality of downstream optical light sources that generate the downstream optical signals, which are wavelength-locked by the sliced light beams multiplexed in the multiplexer, respectively, and output the downstream optical signals to the first multiplexer;
a first demultiplexer that demultiplexes the multiplexed signal of the upstream optical signals received via the second optical fiber; and
a plurality of upstream optical receivers that detect an associated one of the demultiplexed upstream optical signals output from the first demultiplexer.

12. The bi-directional optical access network according to claim 11, wherein the central office further comprises:
a first circulator that outputs the multiplexed signal of the downstream optical signals output from the first multiplexer to the first optical fiber, and outputs the light generated from the broadband light source to the first multiplexer.

13. The bi-directional optical access network according to claim 1, wherein the remote node comprises:
a second demultiplexer that demultiplexes the multiplexed signal of the downstream optical signals received via the first optical fiber, and outputs the demultiplexed downstream optical signals to the subscriber units, respectively; and
a second multiplexer that multiplexes the upstream optical signals respectively output from the subscriber units, and outputs the resultant multiplexed signal of the upstream optical signals to the central office via the second optical fiber.

14. The bi-directional optical access network according to claim 13, wherein the remote node further comprises:
a plurality of second circulators that output an associated one of the demultiplexed downstream optical signals output from the first demultiplexer to an associated one of the subscriber units, and output the upstream optical signal from the associated subscriber unit to the multiplexer.

15. The bi-directional optical access network according to claim 1, wherein each of the subscriber units comprises:
a downstream optical receiver that detects an associated one of the downstream optical signals;
an upstream light source that generates an upstream optical signal wavelength-locked by the remaining portion of the associated downstream optical signal, as the upstream optical signal of the associated subscriber unit; and
a light intensity splitter that splits the associated downstream optical signal into the two portions, to output the two downstream optical signal portions to the downstream optical receiver and the upstream light source, respectively, and to output the upstream optical signal generated from the upstream light source to an associated the third optical fibers.

16. The bi-directional optical access network according to claim 1, wherein each of the subscriber units comprises:
a light intensity splitter that splits the downstream optical signal received from an associated third optical fibers into the two portions, and to output the upstream optical signal from the associated subscriber to the associated third optical fiber;
a downstream optical receiver that detects one of the downstream optical signal portions output from the light intensity splitter;
an upstream light source that generates an upstream optical signal wavelength-locked by the remaining downstream optical signal portion; and
a second circulator arranged between the upstream light source and an associated fourth optical fibers to output the remaining downstream optical signal portion from the light intensity splitter to the upstream light source, and to output the upstream optical signal generated from the upstream light source to the associated fourth optical fiber.

17. The bi-directional optical access network according to claim 15, wherein the upstream light source comprises a Fabry-Perot laser.

18. The bi-directional optical access network according to claim 15, wherein the upstream light source comprises a semiconductor optical amplifier.

19. A bi-directional optical access network comprising:
a central office configured to generate a plurality of wavelength-locked downstream optical signals, to multiplex the downstream optical signals, and to output the resultant multiplexed signal;
a remote node configured to demultiplex the multiplexed signal of the downstream optical signals output from the central office, to output the demultiplexed downstream optical signals to subscriber units, respectively, to multiplex upstream optical signals, and to output the resultant multiplexed signal of the upstream optical signals to the central office,
wherein the subscriber units are configured to detect an associated one of the downstream optical signals, to generate an associated one of the upstream optical signals, which is wavelength-locked by the associated downstream optical signal, and to output the associated upstream optical signal to the remote node; and
a first optical fiber that is used to link the central office and the remote node to transmit the multiplexed signal of the downstream optical signals to the remote node, and to transmit the multiplexed signal of the upstream optical signals to the central office.

20. The bi-directional optical access network according to claim 19, further comprising:
a plurality of second optical fibers that are used to link the remote node and an associated one of the subscriber units to transmit an associated one of the demultiplexed downstream optical signals output from the remote node to the associated subscriber unit, and to transmit the upstream optical signal generated from the associated subscriber unit to the remote node.

21. The bi-directional optical access network according to claim 19, wherein the central office comprises:
a broadband light source configured to generate light having a broad wavelength band;
a first multiplexer/demultiplexer (MUX/DEMUX) configured to multiplex the downstream optical signals, to demultiplex the multiplexed upstream optical signals, and to demultiplex the light into a plurality of sliced light beams respectively corresponding to different wavelengths in the broad wavelength band;
a first circulator configured to output the multiplexed signal of the upstream optical signals received via the first optical fiber to the MUX/DEMUX, and to transmit the multiplexed signal of the downstream optical signals to the first optical fiber; and
a second circulator arranged between the first MUX/DEMUX and the first circulator and connected to the broadband light source to output the light to the first MUX/DEMUX, and to output the multiplexed signal of the downstream optical signals to the first circulator.

22. The bi-directional optical access network according to claim 21, wherein the central office further comprises:
a plurality of downstream light sources configured to generate a downstream optical signal wavelength-locked by an associated one of the sliced light beams demultiplexed in the first MUX/DEMUX, as an associated one of the wavelength-locked downstream optical signals; and
a plurality of upstream optical receivers configured to detect an associated one of the upstream optical signals demultiplexed in the first MUX/DEMUX.

23. The bi-directional optical access network according to claim 19, wherein the remote node comprises:
a second multiplexer/demultiplexer (MUX/DEMUX) linked to the central office by the first optical fiber to demultiplex the multiplexed signal of the downstream optical signals output from the central office, to output the demultiplexed downstream optical signals to the subscriber units, respectively, to multiplex the upstream optical signals respectively outputted from the subscriber units, and to output the resultant multiplexed signal of the upstream optical signals to the central office.

24. The bi-directional optical access network according to claim 19, wherein the central office comprises:
a broadband light source configured to generate light of a broad wavelength band;
a multiplexer configured to slice the light generated from the broadband light source into a plurality of sliced light beams, and to multiplex the downstream optical signals;
a demultiplexer configured to demultiplex the multiplexed signal of the downstream optical signals;
a first circulator configured to output the multiplexed signal of the upstream optical signals received via the first optical fiber to the demultiplexer, and to transmit the multiplexed signal of the downstream optical signals from the multiplexer to the first optical fiber;
a second circulator arranged between the first circulator and the first multiplexer and connected to the broadband light source to output the light to the multiplexer, and to output the multiplexed signal of the downstream optical signals from the multiplexer to the first circulator;
a plurality of downstream optical light sources configured to generate the downstream optical signals, which are wavelength-locked by the sliced light beams demultiplexed in the multiplexer, respectively, and to output the downstream optical signals to the multiplexer; and
a plurality of upstream optical receivers configured to detect an associated one of the demultiplexed upstream optical signals output from the demultiplexer.

25. The bi-directional optical access network according to claim 19, wherein the remote node comprises:
a multiplexer/demultiplexer (MUX/DEMUX) linked to the central office by the first optical fiber to demultiplex the multiplexed signal of the downstream optical signals, to output the demultiplexed downstream optical signals to the subscribers, respectively, to multiplex the upstream optical signals respectively outputted from the subscriber units, and to output the resultant multiplexed signal of the upstream optical signals to the central office.

26. The bidirectional optical access network according to claim 19, wherein each of the subscriber units comprises:
a downstream optical receiver configured to detect an associated one of the downstream optical signals;
an upstream light source configured to generate an upstream optical signal wavelength-locked by the associated second downstream optical signal, as the upstream optical signal of the associated subscriber unit; and
a light intensity splitter linked to the remote node by an associated one of the second optical fibers, the light intensity splitter splitting the associated downstream optical signal into two portions to output the two downstream optical signal portions to the downstream optical receiver and the upstream light source, respectively, and to output the upstream optical signal generated from the upstream light source to the remote node.

27. A method for a bi-directional optical access network, the method comprising the steps of:
receiving a downstream multiplexed signal of a plurality of wavelength-locked downstream optical signals;
demultiplexing the multiplexed signal;
outputting the demultiplexed downstream optical signals to a plurality of subscriber units, respectively;
slicing an associated one of the downstream optical signals and detecting a portion of the associated downstream optical signal;
generating an associated one of the upstream optical signals, which is wavelength-locked by the remaining portion of the associated downstream optical signal;
outputting the associated upstream optical signal;
multiplexing upstream optical signals; and
outputting the resultant upstream multiplexed signal.
